(19) United States
(12) Patent Application Publication
(10) Pub. No.: US 2026/0333499 A1
(43) Pub. Date: Oct. 22, 2026

(54) METHOD AND APPARATUS FOR SUPPORTING SSC MODE ON PC5 LINKS

(71) Applicant: SAMSUNG ELECTRONICS CO., LTD., Suwon-si, Gyeonggi-do (KR)

(72) Inventors: Mahmoud WATFA, Staines, Middlesex (GB); Tingyu XIN, Staines, Middlesex (GB)

(21) Appl. No.: 19/158,338

(22) PCT Filed: Feb. 19, 2024
(86) PCT No.: PCT/KR2024/095407

§ 371 Date: Aug. 20, 2025

(30) Foreign Application Priority Data
Feb. 20, 2023 (GB) 2302359.1
Jan. 19, 2024 (GB) 2400760.1

(51) Int. Cl. H04W 76/23; H04W 76/30

(52) U.S. Cl. CPC H04W 76/23; H04W 76/30

(57) ABSTRACT

The disclosure relates to a 5G or 6G communication Remote UE Relay UE e.g. Network system for supporting a higher data transmission rate. A method performed by a relay user equipment (UE) in a wireless communication system is provided. The method comprises receiving, from a base station, a protocol data unit (PDU) session modification command message associated with a first PDU session, the PDU session modification command message including a cause value for requesting a PDU session reactivation, establishing a second PDU session based on the PDU session modification command message and initiating a release procedure for a PC5 direct link associated with the first PDU session established for relaying a traffic of a remote UE.

### TECHNICAL FIELD

The present disclosure relates generally to wireless communication systems and, more specifically, relates to a method and apparatus for supporting a SSC mode on PC5 links.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mm Wave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mm Wave, supporting numerologies (for example, operating multiple subcarrier spacings) for efficiently utilizing mm Wave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/ protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### DISCLOSURE OF INVENTION

### Solution to Problem

A method performed by a relay user equipment (UE) in a wireless communication system is provided. The method comprises receiving, from a base station, a protocol data unit (PDU) session modification command message associated with a first PDU session, the PDU session modification command message including a cause value for requesting a PDU session reactivation, establishing a second PDU session based on the PDU session modification command message and initiating a release procedure for a PC5 direct link associated with the first PDU session established for relaying a traffic of a remote UE.

A relay user equipment (UE) in a wireless communication system is provided. The relay UE comprises a transceiver and a controller coupled with the transceiver and configured to receive, from a base station, a protocol data unit (PDU) session modification command message associated with a first PDU session, the PDU session modification command message including a cause value for requesting a PDU session reactivation, establish a second PDU session based on the PDU session modification command message, and initiate a release procedure for a PC5 direct link associated with the first PDU session established for relaying a traffic of a remote UE.

### BRIEF DESCRIPTION OF DRAWINGS

For a more complete understanding of the present disclosure and its advantages, reference is now made to the following description taken in conjunction with the accompanying drawings, in which like reference numerals represent like parts:

FIG. 1 illustrates 5G ProSe Communication via 5G ProSe Layer-3 UE-to-Network Relay without N3IWF;

FIG. 2 illustrates a method for performing relaying between a remote UE and Nework according to an embodiment of the present disclosure;

FIG. 3 is a block diagram of an exemplary network entity according to an embodiment.

### BEST MODE FOR CARRYING OUT THE INVENTION

The following description of examples of the present disclosure, with reference to the accompanying drawings, is provided to assist in a comprehensive understanding of the present invention, as defined by the claims. The description includes various specific details to assist in that understanding but these are to be regarded as merely exemplary. Accordingly, those of ordinary skill in the art will recognize that various changes and modifications of the examples described herein can be made without departing from the scope of the invention.

The same or similar components may be designated by the same or similar reference numerals, although they may be illustrated in different drawings.

Detailed descriptions of techniques, structures, functions, operations or processes known in the art may be omitted for clarity and conciseness, and to avoid obscuring the subject matter of the present invention.

The terms and words used herein are not limited to the bibliographical or standard meanings, but, are merely used to enable a clear and consistent understanding of the invention.

Throughout the description and claims of this specification, the words “comprise”, “include” and “contain” and variations of the words, for example “comprising” and “comprises”, means “including but not limited to”, and is not intended to (and does not) exclude other features, elements, components, integers, steps, processes, operations, functions, characteristics, properties and/or groups thereof.

Throughout the description and claims of this specification, the singular form, for example “a”, “an” and “the”, encompasses the plural unless the context otherwise requires. For example, reference to “an object” includes reference to one or more of such objects.

Throughout the description and claims of this specification, language in the general form of “X for Y” (where Y is some action, process, operation, function, activity or step and X is some means for carrying out that action, process, operation, function, activity or step) encompasses means X adapted, configured or arranged specifically, but not necessarily exclusively, to do Y.

Features, elements, components, integers, steps, processes, operations, functions, characteristics, properties and/or groups thereof described or disclosed in conjunction with a particular aspect, embodiment, example or claim are to be understood to be applicable to any other aspect, embodiment, example or claim described herein unless incompatible therewith.

The skilled person will appreciate that the techniques described herein may be used in any suitable combination.

Certain examples of the present disclosure provide one or more techniques relating to Service and Session Continuity (SSC) Mode on PC5 links, for example in a 3rd Generation Partnership Project (3GPP) 5th Generation (5G) New Radio (NR) network.

Herein, the following documents are referenced:
[1] 3GPP TS 23.501 V 18.0.0
[2] 3GPP TS 24.501 V 18.1.0
[3] 3GPP TS 23.502 V 18.0.0
[4] 3GPP TS 23.304 V 17.3.0
[5] 3GPP TS 24.554

Various acronyms and abbreviations used herein are defined at the end of this description.

### Overview of SSC Modes of PDU sessions

The 5GS defines three types of SSC (Service & Session Continuity) modes one of which may apply to a PDU session. The following is from section 5.6.9.1 in [1]:

“The support for session and service continuity in 5G System architecture enables to address the various continuity requirements of different applications/services for the UE. The 5G System supports different session and service continuity (SSC) modes defined in this clause. The SSC mode associated with a PDU Session does not change during the lifetime of a PDU Session. The following three modes are specified with further details provided in the next clause:
With SSC mode 1, the network preserves the connectivity service provided to the UE. For the case of PDU Session of IPv4 or IPv6 or IPv4v6 type, the IP address is preserved.
With SSC mode 2, the network may release the connectivity service delivered to the UE and release the corresponding PDU Session(s). For the case of IPv4 or IPv6 or IPv4v6 type, the release of the PDU Session induces the release of IP address(es) that had been allocated to the UE.
With SSC mode 3, changes to the user plane can be visible to the UE, while the network ensures that the UE suffers no loss of connectivity. A connection through new PDU Session Anchor point is established before the previous connection is terminated in order to allow for better service continuity. For the case of IPv4 or IPv6 or IPv4v6 type, the IP address is not preserved in this mode when the PDU Session Anchor changes.

NOTE: In this Release of the specification, the addition/removal procedure of additional PDU Session Anchor in a PDU Session for local access to a DN is independent from the SSC mode of the PDU Session.”

For example, with SSC mode 3, a UE with one PDU session, say PDU session #3, will setup a new PDU session, say PDU session #4, such that the latter will be used for the UE's traffic and the previous session will be released. This change will lead to a change in IP address as indicated above. Although the new session is established before the previous one is released, and even though the service continuity may be enabled with this “make before break” concept, a change in the IP address will be required and hence local changes to the IP packet filters, packet matching, etc, will be needed at the UE.

The SMF is the entity that triggers the re-establishment of the PDU session due to the functions related to SSC mode 3. The following is from section 6.3.2.2 of [2] which describes the SMF behaviour for this purpose:

“If the selected SSC mode of the PDU session is “SSC mode 3” and the SMF requests the relocation of SSC mode 3 PDU session anchor with multiple PDU sessions as specified in 3GPP TS 23.502[9], the SMF shall include 5GSM cause #39 “reactivation requested”, in the PDU SESSION MODIFICATION COMMAND message, and may include the PDU session address lifetime in a PDU session address lifetime parameter in the Extended protocol configuration options IE of the PDU SESSION MODIFICATION COMMAND message.”

The following is from section 6.3.2.3 in [2] which describes the UE behaviour after receiving the NAS message with 5GSM cause #39 as quoted above:

“If the selected SSC mode of the PDU session is “SSC mode 3” and the PDU SESSION MODIFICATION COMMAND message includes 5GSM cause #39 “reactivation requested”, the UE can provide to the upper layers the PDU session address lifetime if received in the PDU session address lifetime parameter of the Extended protocol configuration options IE of the PDU SESSION MODIFICATION COMMAND message. After the completion of the network-requested PDU session modification procedure:
a)if the PDU session is an MA PDU session:
1)established over both 3GPP access and non-3GPP access, and:
the UE is registered over both 3GPP access and non-3GPP access in the same PLMN:
   the UE should re-initiate a UE-requested PDU session establishment procedure as specified in subclause 6.4.1 over the access the PDU SESSION MODIFICATION COMMAND message is received; or
the UE is registered over both 3GPP access and non-3GPP access in different PLMNs:
   the UE should re-initiate UE-requested PDU session establishment procedures as specified in subclause 6.4.1 over both accesses. The UE should re-initiate the UE-requested PDU session establishment procedure over the access the PDU SESSION MODIFICATION COMMAND message is received first; or
2)established over only single access:
the UE should re-initiate a UE-requested PDU session establishment procedure as specified in subclause 6.4.1 over the access the user plane resources were established; or
b)if the PDU session is a single access PDU session:
the UE should re-initiate a UE-requested PDU session establishment procedure as specified in subclause 6.4.1 over the access the PDU session was associated with; and
for the re-initiated UE-requested PDU session establishment procedure(s) the UE should set a new PDU session ID different from the PDU session ID associated with the present PDU session and should set:
a)the PDU session type to the PDU session type associated with the present PDU session;
b)the SSC mode to the SSC mode associated with the present PDU session;
c)the DNN to the DNN associated with the present PDU session; and
d)the S-NSSAI to the S-NSSAI associated with (if available in roaming scenarios) a mapped S-NSSAI if provided in the UE-requested PDU session establishment procedure of the present PDU session.”

Note that in the context of 5G ProSe, the focus is mostly on single access PDU session and in this case, per the excerpt shown above, the UE would request the establishment of a new PDU session which would have a different PDU session ID, however the parameters associated with the new session—i.e. the SSC mode, DNN, S-NSSAI—would be set to the same values of the current PDU session.

Note that the PDU Session Modification Command message, sent with 5GSM cause #39, may contain a PDU Session Address Lifetime which informs the UE the duration of the time that the session will be kept. After this time expires in the network, the SMF will release the old/previous PDU session. However, as long as the network has not done so, the UE should keep the session unless the upper layers in the UE indicate that the session is no longer needed as described in section 6.3.2.3 in [2]:

“NOTE 6: The UE is expected to maintain the PDU session for which the PDU SESSION MODIFICATION COMMAND message including 5GSM cause #39 “reactivation requested” is received during the time indicated by the PDU session address lifetime value or until receiving an indication from upper layers (e.g. that the old PDU session is no more needed).”

Therefore, to summarize, for a PDU session for which the SSC mode is 3, the network may request the UE to re-establish a new PDU session which will have the same session parameters. The network will eventually release the old/previous PDU session after a certain time elapses. It is the responsibility of the UE to move traffic flows from the first/old/previous PDU session to the new PDU session. However, how this is done is out of scope of 3GPP as described in section 4.3.5.2 of [3]:

“NOTE: The mechanisms used by the UE to proactively move existing traffic flows from one IP address/prefix to another are outside the scope of 3GPP specifications.”

### Overview of Layer 3 UE-to-Network Relay UE (Without N3IWF) for 5G ProSe

One of the services in 5GS is proximity services which enables a remote UE (called remote because it is out of coverage of RAN) uses a relay UE (called relay because it enables the remote UE to communicate with a network, where the relay UE is in coverage) to exchange data with a data network. One type of remote UE is referred to as a layer 3 (L3) remote UE because it uses a L3 UE-to-network relay UE (hereafter referred to as a relay UE). The following is from [4] showing the overall procedure for a remote UE which connects to a relay UE (both being L3 UEs):

“6.5.1.15G ProSe Communication via 5G ProSe Layer-3 UE-to-Network Relay without N3IWF

A 5G ProSe Layer-3 UE-to-Network Relay registers to the network (if not already registered). 5G ProSe Layer-3 UE-to-Network Relay establishes a PDU Session(s) or modifies an existing PDU Session(s) in order to provide relay traffic towards 5G ProSe Layer-3 Remote UE(s). PDU Session(s) supporting 5G ProSe Layer-3 UE-to-Network Relay shall only be used for 5G ProSe Layer-3 Remote UE(s) relay traffic. The PLMN serving the 5G ProSe Layer-3 UE-to-Network Relay and the PLMN to which the 5G ProSe Layer-3 Remote UE registers can be the same PLMN or two different PLMNs.
1.Service authorization and provisioning are performed for the 5G ProSe Layer-3 UE-to-Network Relay (step 1a) and 5G ProSe Layer-3 Remote UE (step 1b) as described in clause 6.2.
2.The 5G ProSe Layer-3 UE-to-Network Relay may establish a PDU Session for relaying. In the case of IPv6, the 5G ProSe Layer-3 UE-to-Network Relay obtains the IPv6 prefix via prefix delegation function from the network as defined in TS 23.501 [4].
NOTE 1:5G ProSe Layer-3 UE-to-Network Relay can establish a PDU Session for any Relay Service Code it supports before the connection is established with the 5G ProSe Layer-3 Remote UE.
3.The 5G ProSe Layer-3 Remote UE performs discovery of a 5G ProSe Layer-3 UE-to-Network Relay as described in clause 6.3.2.3. As part of the discovery procedure the 5G ProSe Layer-3 Remote UE learns about the connectivity service the 5G ProSe Layer-3 UE-to-Network Relay provides.
4.The 5G ProSe Layer-3 Remote UE selects a 5G ProSe Layer-3 UE-to-Network Relay and establishes a connection for unicast mode communication as described in clause 6.4.3.6. If there is no PDU Session associated with the Relay Service Code or a new PDU Session for relaying is needed, the 5G ProSe Layer-3 UE-to-Network Relay initiates a new PDU Session establishment procedure for relaying before completing the PC5 connection establishment.

The network decides that the PDU session to be established is for relay traffic, and then generates the QoS rules and QoS Flow level QoS parameters to 5G ProSe Layer-3 UE-to-Network Relay with relay consideration and can initiate the setup of QoS flows as specified in clause 5.6.2.1. The Remote UE can also initiate the setup of QoS flows by providing PC5 QoS info and (optionally) PC5 QoS rule(s) to the 5G ProSe Layer-3 UE-to-Network Relay during connection setup, according to the procedure as specified in clause 5.6.2.1.

The 5G ProSe Layer-3 UE-to-Network Relay determines the PDU Session type for relaying as specified in clause 5.4.1.1.

According to the PDU Session Type for relaying, the 5G ProSe Layer-3 UE-to-Network Relay performs relaying function at the corresponding layer as follows:
When the IP type PDU Session is used for IP traffic over PC5 reference point, the 5G ProSe Layer-3 UE-to-Network Relay acts as an IP router. For IPv4, the 5G ProSe Layer-3 UE-to-Network Relay performs IPv4 NAT between IPv4 addresses assigned to the 5G ProSe Layer-3 Remote UE and the IPv4 address assigned to the PDU Session used for the relay traffic.
When the Ethernet type PDU Session is used for Ethernet traffic over PC5 reference point, the 5G ProSe Layer-3 UE-to-Network Relay acts as an Ethernet switch.
When the Unstructured type PDU Session is used for Unstructured traffic over PC5 reference point, the 5G ProSe Layer-3 UE-to-Network Relay performs traffic relaying based on a mapping between the PC5 Link Identifier and the PDU Session ID, and a mapping between PFI for PC5 Layer-2 link and the QFI for the PDU Session. These mappings are created when the Unstructured type PDU Session is established for the 5G ProSe Layer-3 Remote UE.
When the IP type PDU Session is used for Ethernet or Unstructured traffic over PC 5 reference point, the 5G ProSe Layer-3 UE-to-Network Relay uses IP tunneling. For this IP tunnelling, the 5G ProSe Layer-3 UE-to-Network Relay locally assigns an IP address/prefix for the 5G ProSe Layer-3 Remote UE and uses it on the Uu reference point to encapsulate and decapsulate the uplink and downlink traffic for the 5G ProSe Layer-3 Remote UE. The tunnelled traffic over Uu reference point is transported over the PC5 reference point as Ethernet or Unstructured traffic.
5.For IP PDU Session Type and IP traffic over PC 5 reference point, IPv6 prefix or IPv4 address (including NAT case) is allocated for the 5G ProSe Layer-3 Remote UE as defined in clause 5.5.1.3.
6.The 5G ProSe Layer-3 Remote UE may provide PC5 QoS Info and PC5 QoS rule(s) to the 5G ProSe Layer-3 UE-to-Network Relay using Layer-2 link modification procedure as specified in clause 6.4.3.4. The 5G ProSe Layer-3 UE-to-Network Relay generates the Packet Filters used over Uu interface based on the received PC5 QoS Info and QoS Rule(s) as described in clause 5.6.2.1, and may perform the UE requested PDU Session Modification as defined in TS 23.502 [5] clause 4.3.3 to setup a new QoS Flow or bind the traffic to an existing QoS Flow.

From this point the uplink and downlink relaying can start. For downlink traffic forwarding, the PC5 QoS Rule is used to map the downlink packet to the PC5 QoS Flow. For uplink traffic forwarding, the 5G QoS Rule is used to map the uplink packet to the Uu QoS flow.
7.The 5G ProSe Layer-3 UE-to-Network Relay shall send a Remote UE Report (Remote User ID, Remote UE info) message to the SMF for the PDU Session associated with the relay. The Remote User ID is an identity of the 5G ProSe Layer-3 Remote UE user that was successfully connected in step 4. The Remote UE info is used to assist identifying the 5G ProSe Layer-3 Remote UE in the 5GC. For IP PDU Session Type, the Remote UE info is Remote UE IP info. For Ethernet PDU Session Type, the Remote UE info is Remote UE MAC address which is detected by the 5G ProSe Layer-3 UE-to-Network Relay. For Unstructured PDU Session Type, the Remote UE info is not included. The SMF stores the Remote User IDs and the related Remote UE info in the 5G ProSe Layer-3 UE-to-Network Relay's SM context for this PDU Session associated with the relay.

The Remote UE Report is NI SM NAS message sent with the PDU Session ID to the AMF, in turn delivered to the SMF.
NOTE 2: The privacy protection for Remote User ID depends on SA WG3 design.

For IP info the following principles apply:
for IPv4, the 5G ProSe Layer-3 UE-to-Network Relay shall report TCP/UDP port ranges assigned to individual 5G ProSe Layer-3 Remote UE(s) (along with the Remote User ID);
for IPv6, the 5G ProSe Layer-3 UE-to-Network Relay shall report IPv6 prefix(es) assigned to individual 5G ProSe Layer-3 Remote UE(s) (along with the Remote User ID).

If the PDU Session for relaying is released by the UE-to-Network Relay or the network as described in clause 4.3.4 of TS 23.502 [5], the UE-to-Network Relay should initiate the release of the layer-2 links associated with the released PDU Session using the procedure defined in clause 6.4.3.3.

The PDU Session(s) used for relaying should be released as described in clause 4.3.4 of TS 23.502 [5] (e.g. by 5G ProSe Layer-3 UE-to-Network Relay), if the service authorization for acting as a 5G ProSe Layer-3 UE-to-Network Relay in the serving PLMN is revoked.

The 5G ProSe Layer-3 UE-to-Network Relay shall send the Remote UE Report message when the 5G ProSe Layer-3 Remote UE disconnects from the 5G ProSe Layer-3 UE-to-Network Relay (e.g. upon explicit layer-2 link release or based on the absence of keep alive messages over PC 5) to inform the SMF that the 5G ProSe Layer-3 Remote UE(s) have left.
NOTE 3: In order for the SMF to have the 5G ProSe Layer-3 Remote UE(s) information, the HPLMN and the VPLMN where the 5G ProSe Layer-3 UE-to-Network Relay is authorised to operate, needs to support the transfer of the 5G ProSe Layer-3 Remote UE related parameters if the SMF is in the HPLMN.

It is up to 5G ProSe Layer-3 UE-to-Network Relay implementation how PDU Session(s) used for relaying are released or QoS Flow(s) used for relaying are removed by the 5G ProSe Layer-3 UE-to-Network Relay when 5G ProSe Layer-3 Remote UE(s) disconnect from the 5G ProSe Layer-3 UE-to-Network Relay.”

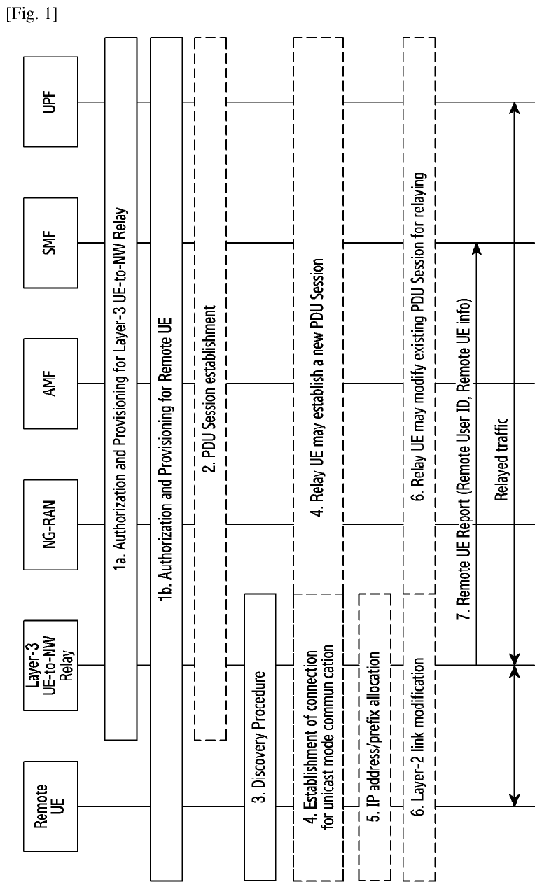

When a relay UE provides services to a remote UE, both UEs will normally exchange and agree on their IP addresses as shown in step 5 of FIG. 1. The following is also from [4] about IP address allocation for the L3 remote UE:

“5.5.1.3IP address allocation for communication with a 5G ProSe Layer-3 ProSe UE-to-Network Relay

For communication with a 5G ProSe Layer-3 UE-to-Network Relay, the following mechanism for IP address/prefix allocation applies:
The PDU Session Type used for the relay traffic shall support the IP version used by the 5G ProSe Layer-3 Remote UE. If the 5G ProSe Layer-3 Remote UE initiates an allocation of IPv4 address or an IPv6 prefix when the requested IP version is not supported in the corresponding PDU Session then IP address/prefix allocation fails.
a)When the 5G ProSe Layer-3 Remote UE uses IPv4 to access the external DN:
a1)The IPv4 address allocation and IPv4 parameter configuration via DHCPv4 are performed according to RFC 2131 [24] and RFC 4039 [25] procedures. The IPv4 address provided to the 5G ProSe Layer-3 Remote UE from the 5G ProSe Layer-3 UE-to-Network Relay by DHCPv4 procedure shall correspond to a local IPv4 address range configured in the 5G ProSe Layer-3 UE-to-Network Relay.
a2)The DHCPv4 request from the 5G ProSe Layer-3 Remote UE is always sent subsequent to the establishment of the one-to-one 5G ProSe Direct Communication between the 5G ProSe Layer-3 Remote UE and the 5G ProSe Layer-3 UE-to-Network Relay, see details for the IPv4 address allocation in clause 5.4.4.3 of TS 23.303 [3] with the following difference:
The ProSe Relay UE ID of the ProSe UE-to-Network Relay is replaced by the source Layer-2 ID of the 5G ProSe UE-to-Network Relay for PC5 unicast communication.
b)When the 5G ProSe Layer-3 Remote UE uses IPv6 to access the external DN:
b1)IPv6 network prefix allocation via IPv6 Stateless Address auto-configuration. Router solicitation from the 5G ProSe Layer-3 Remote UE is always sent subsequent to the establishment of the one-to-one ProSe Direct Communication between the 5G ProSe Layer-3 Remote UE and the 5G ProSe Layer-3 UE-to-Network Relay, see details for IPv6 prefix allocation in clause 5.4.4.2 of TS 23.303 [3] with the following differences:
The 5G ProSe Layer-3 UE-to-Network Relay shall obtain the IPv6 prefix assigned to the 5G ProSe Layer-3 Remote UE via prefix delegation function from the network as defined in clause 5.5.2.
The ProSe Relay UE ID of the ProSe UE-to-Network Relay is replaced by the source Layer-2 ID of the 5G ProSe UE-to-Network Relay for PC 5 unicast communication.
PDN connection is replaced by PDU Session.
b2)IPv6 parameter configuration via Stateless DHCPv6: The UE may use stateless DHCPv6 for additional parameter configuration.
b3)The 5G ProSe Layer-3 UE-to-Network Relay assigns IPv6 prefixes from IPv6 prefix range that have been assigned to the PDU Session used for the relay traffic via IPv6 prefix delegation.

### 5.5.2IPv6 Prefix Delegation via DHCPv6 for 5G ProSe Layer-3 UE-to-Network Relay

Optionally a single network prefix shorter than the default/64 prefix may be assigned to a PDU Session. In this case, the/64 default prefix used for IPv6 stateless autoconfiguration will be allocated from this network prefix; the remaining address space from the network prefix can be delegated to the PDU Session using prefix delegation after the PDU Session establishment and IPv6 prefix allocation via IPv6 stateless address autoconfiguration as defined in clause 5.8.2.2.3 of TS 23.501 [4]. When PLMN based parameter configuration is used, the SMF provides the requested IPv6 prefix from a locally provisioned pool. When external DN based IPv6 prefix allocation is used, the SMF obtains the prefix from the external DN.

NOTE: Allocation of IPv6 prefixes with flexible prefix length can leverage e.g. local configuration on the SMF or interaction with the AAA server.

The address space provided is maintained as an IPv6 address space pool available to the PDU Session for DHCPv6 IPv6 prefix requests with the exclusion of the IPv6 prefix that is allocated to the PDU Session during PDU Session establishment as defined in clause 5.8.2.2.3 of TS 23.501 [4]. The total IPv6 address space available for the PDU Session (UE PDU Session prefix and UE PDU Session IPv6 address space pool) shall be possible to aggregate into one IPv6 prefix that will represent all IPv6 addresses that the UE may use. If the UE had indicated that it supports prefix exclusion and the prefix to be delegated to the UE includes the/64 prefix that was allocated to the PDU Session, the SMF shall utilise the prefix exclusion feature as specified for DHCPv6 Prefix Delegation in RFC 6603 [26].

The UE uses DHCPv6 to request additional IPv6 prefixes (i.e. prefixes in addition to the default prefix) from the SMF after completing stateless IPv6 address autoconfiguration procedures. The UE acts as a “Requesting Router” as described in RFC 8415 [27] and inserts one or more IA_PD option(s) into a DHCPv6 Solicit message sent from the UE to the SMF. The SMF acts as the DHCP server and fulfils the role of a “Delegating Router” according to RFC 841 [27]. The UE optionally includes the RAPID_COMMIT option in the DHCPv6 Solicit message to trigger two-message DHCPv6 procedure instead of the four-message DHCPv6 procedure. The UE shall include OPTION_PD_EXCLUDE option code in an OPTION_ORO option to indicate support for prefix exclusion. In response to the DHCPv6 Solicit message, the UE receives a DHCPv6 Reply message with one or more IA_PD prefix(es) for every IA_PD option that it sent in the DHCPv6 Solicit message. The SMF delegates a prefix excluding the default prefix with help of OPTION_PD_EXCLUDE. Prefix exclusion procedures shall follow RFC 6603 [26].”

The following is from [5], the stage-3 specification of the 5G Proximity Services feature, which describes the IP address allocation procedure as well:

“8.2.5IP address allocation for 5G ProSe remote UE in 5G ProSe layer-3 UE-to-network relay procedure

When one of the two UEs on the direct link acts as a 5G ProSe layer-3 UE-to-network relay UE, the PDU session type is IPv4, IPv6 or IPv4v6 and is used for relaying IP traffic over PC5 reference point, the two UEs shall select the IP version (IPv4 or IPv6) to be used based on the following rules:
a)if the 5G ProSe layer-3 UE-to-network relay UE has indicated “DHCPv4 Server” in the IP address configuration IE, the 5G ProSe remote UE shall initiate the IPv4 address configuration with DHCPv4 procedure acting as a DHCP client, according to IETF RFC 2131 [23] and IETF RFC 4039 [24];
b)if the 5G ProSe layer-3 UE-to-network relay UE has indicated “IPv6 Router” in the IP address configuration IE, the 5G ProSe remote UE shall initiate the IPv6 address configuration with IPv6 stateless address auto-configuration acting as an IPv6 host based on IETF RFC 4862 [25];

NOTE: The 5G ProSe layer-3 UE-to-network relay UE uses IPv6 prefix delegation via DHCPv6 (see clause 8.2.5a) to obtain the IPv6 prefix assigned to the 5G ProSe layer-3 remote UE.
c)if the 5G ProSe layer-3 UE-to-network relay UE has indicated “IPv6 Router” in the IP address configuration IE, the 5G ProSe remote UE may use stateless DHCPv6 for additional parameter configuration, as defined in TS 23.501[22]; and
d)if the 5G ProSe layer-3 UE-to-network relay UE has indicated “DHCPv4 Server & IPv6 Router” in the IP address configuration IE, the 5G ProSe remote UE shall choose the IP version and initiate the corresponding IP address configuration procedure as a client or host.
   8.2.5aIPv6 Prefix Delegation via DHCPv6 for 5G ProSe layer-3 UE-to-network Relay

If the 5G ProSe layer-3 UE-to-network relay UE can indicate “IPv6 Router” or “DHCPv4 Server & IPv6 Router” in the IP address configuration IE, the 5G ProSe layer-3 UE-to-network relay UE requests additional IPv6 prefixes (i.e., prefixes in addition to the/64 default prefix which was allocated via stateless IPv6 address auto-configuration) from the SMF as specified in 3GPP TS 24.501 [11].

Once the 5G ProSe layer-3 UE-to-network relay UE successfully obtains the network prefix shorter than the default/64 prefix using DHCPv6, the 5G ProSe layer-3 UE-to-network relay UE can assign/64 prefix from the network prefix when the 5G ProSe layer-3 UE-to-network remote UE requests IPv6 prefix via stateless IPv6 address auto-configuration.”

At least for some of the options listed above, the relay UE provides a prefix to the remote UE. This prefix is associated with the relay's IP address prefix such that if the PDU session of the relay UE is changed then the IP address of the remote UEs will also be affected.

The above information is presented as background information only to assist with an understanding of the present disclosure. No determination has been made, and no assertion is made, as to whether any of the above might be applicable as prior art with regard to the present invention.

It is an aim of certain examples of the present disclosure to address, solve and/or mitigate, at least partly, at least one of the problems and/or disadvantages associated with the related art, for example at least one of the problems and/or disadvantages described herein. It is an aim of certain examples of the present disclosure to provide at least one advantage over the related art, for example at least one of the advantages described herein.

The present invention is defined in the independent claims. Advantageous features are defined in the dependent claims.

Embodiments or examples disclosed in the description and/or figures falling outside the scope of the claims are to be understood as examples useful for understanding the present invention.

Other aspects, advantages and salient features of the invention will become apparent to those skilled in the art from the following detailed description taken in conjunction with the accompanying drawings.

Certain examples of the present disclosure provide one or more techniques relating to SSC Mode on PC5 links, for example in a 3GPP 5G New Radio NR network.

However, the skilled person will appreciate that the present invention is not limited to these examples, and may be applied in any suitable system or standard, for example one or more existing and/or future generation wireless communication systems or standards, including any existing or future releases of the same standards specification, for example 3GPP 5G.

The functionality of the various network entities and other features disclosed herein may be applied to corresponding or equivalent entities or features in the same or any other suitable communication systems or standards. Corresponding or equivalent entities or features may be regarded as entities or features that perform the same or similar role, function or purpose within the network.

The skilled person will appreciate that the various examples disclosed herein may be implemented using existing messages (e.g. Radio Resource Control (RRC) messages) or any other suitable messages. The skilled person will appreciate that the names of messages may vary across different Radio Access Technologies (RATs), for example NR and LTE. The skilled person will appreciate that examples disclosed herein referring to message names in one particular RAT are not limited to that RAT, but may be applied to other RATs.

Certain examples of the present disclosure may be provided in the form of an apparatus/device/network entity configured to perform one or more defined network functions and/or a method therefor. Certain examples of the present disclosure may be provided in the form of a system (e.g. network or wireless communication system) comprising one or more such apparatuses/devices/network entities, and/or a method therefor.

A particular network entity may be implemented as a network element on a dedicated hardware, as a software instance running on a dedicated hardware, and/or as a virtualised function instantiated on an appropriate platform, e.g. on a cloud infrastructure.

The skilled person will appreciate that the present invention is not limited to the specific examples disclosed herein. For example:
The techniques disclosed herein are not limited to 3GPP 5G.
One or more entities in the examples disclosed herein may be replaced with one or more alternative entities performing equivalent or corresponding functions, processes or operations.
One or more of the messages in the examples disclosed herein may be replaced with one or more alternative messages, signals or other type of information carriers that communicate equivalent or corresponding information.
One or more further elements or entities may be added to the examples disclosed herein.
One or more non-essential elements or entities may be omitted in certain examples.
The functions, processes or operations of a particular entity in one example may be divided between two or more separate entities in an alternative example.
The functions, processes or operations of two or more separate entities in one example may be performed by a single entity in an alternative example.
Information carried by a particular message in one example may be carried by two or more separate messages in an alternative example.
Information carried by two or more separate messages in one example may be carried by a single message in an alternative example.
The order in which operations are performed and/or the order in which messages are transmitted may be modified, if possible, in alternative examples.

At least the following problem exist in view of the related art.

### For SSC Mode 3, the Relay UE may Establish a new PDU Session Which Will Impact the Remote UE's IP Address

The relay UE may have a PDU session for which the SSC mode is SSC mode 3. The SMF may send the PDU Session Modification Command message indicating that the session will be deactivated, and may provide the PDU session address lifetime which indicates the duration for which the current PDU session will be maintained. If the UE determines to establish another PDU session before the current session is released, then the remote UEs' sessions can only last for the duration of the PDU session address lifetime. If the relay UE does not inform the remote UE's about the change of IP prefix, etc, then the links with the remote UEs will eventually be released as the corresponding PDU session will be released (after the expiry of the PDU session address lifetime) and the remote UEs will have to restart their connection i.e. to re-establish a PC5 link with the relay UE again. This will cause service interruption for the remote UEs. Therefore it is evident that (at least) for SSC mode 3, a change of PDU session will impact the sessions of the remote UEs and no action by the relay UE will lead to service interruption for the remote UE sessions and the delay may be quite big thereby leading to negative user experience.

Certain examples of the present disclosure address, at least, the scenario for which a relay UE (noting that the relay UE is at least a layer 3 UE-to-network relay UE, but not necessarily limited to such a relay UE only and hence may be another type of relay UE) has:
an existing PDU session for which the SSC mode is SSC mode 3
there is at least one remote UE which is being served with this PDU session
the relay UE receives a PDU Session Modification Command message (i.e. as part of a PDU session modification procedure) indicating the session should be (re-)established, where the 5GSM cause value indicates #39 “reactivation requested”, and optionally the Extended Protocol Configuration Options IE includes a PDU session address lifetime.

The relay UE takes new actions towards the remote UE after receiving 5GSM cause value #39 as described earlier.

Certain examples of the present disclosure provide a method, for a first UE providing a relay function between a network and a second UE, wherein a first data session associated with a first IP address is established between the first UE and the network for data relayed between the second UE and the network, the method comprising: receiving, from the network, a message requesting data session modification; and initiating release of a link, between the first UE and the second UE, and associated with the first data session, if (i) the first data session is associated with a predetermined mode, and (ii) the message comprises a predetermined indication.

In certain examples, the predetermined mode may be SSC mode 3.

In certain examples, the predetermined indication may be cause value #39 “reactivation requested”.

In certain examples, the first data session may be a PDU session.

In certain examples, the message may comprise a PDU SESSION MODIFICATION COMMAND message.

In certain examples, the link may comprise a PC5 link.

In certain examples, initiating release of the link may comprise initiating a ProSe direct link release procedure.

In certain examples, the first UE may comprise a ProSe layer-3 UE-to-network relay UE.

In certain examples, the method may further comprise, in response to the message, establishing a second data session, associated with a second IP address different from the first IP address, for data relayed between the second UE and the network.

In certain examples, the second data session may be established before release of the link is initiated.

In certain examples, the second data session may be established before the first data session is terminated.

In certain examples, the second data session may be a PDU session.

In certain examples, the message may comprise information indicating a lifetime of the first data session.

In certain examples, the message may be received from an SMF entity.

In certain examples, the second UE may be out of coverage of the network.

In certain examples, the message may indicate a request to change a data session anchor point.

Certain examples of the present disclosure provide a UE configured to perform a method according to any aspect, example, embodiment and/or claim disclosed herein.

Certain examples of the present disclosure provide a network (or wireless communication system) comprising a first UE, a second UE and a network entity (e.g. an SMF entity) according to any aspects, examples, embodiments and/or claims disclosed herein.

Certain examples of the present disclosure provide a computer program comprising instructions which, when the program is executed by a computer or processor, cause the computer or processor to carry out a method according to any aspect, example, embodiment and/or claim disclosed herein.

Certain examples of the present disclosure provide a computer or processor-readable data carrier having stored thereon a computer program according to any aspect, example, embodiment and/or claim disclosed herein.

In certain examples, a relay UE may behave in accordance with one or more techniques, for example one or more of the options described below.

Note: reception of 5GSM cause #39 is the same as reception of 5GSM cause #39 “re-activation requested”. The use of #39 only is for brevity.
Option 1: Notify the remote UEs about the impacts to the PC5 link (optionally due to SSC mode 3)

When a relay UE, with a PDU session for which the SSC mode is 3, needs to (re-)establish the session due to receiving 5GSM cause value #39, and the relay UE is serving at least one remote UE, where optionally the relay UE is in connected mode or optionally there is an active PC5 link (or direct connection) with at least one remote UE such that data is being exchanged with the remote UE (and optionally the PDU session in question is used for this purpose), then the relay UE may behave using any of the techniques described below in any order or combination:
The relay UE should inform each remote UE about the potential deactivation of the connection. For example, a new PC5 message may be used for this purpose. The relay UE may provide a time value to indicate the duration for which the current connection may be used as is, where the time value may be set to be equal to (or optionally less than) the PDU session address lifetime as determined by the relay UE.

The relay UE may provide a cause value (on the PC5 link) to indicate that the reason is due to (a pending) reactivation of the PDU session on the Uu interface (e.g. due to SSC mode 3). Note that any new cause value may be defined. Optionally the relay UE may request the remote UE to re-establish a new PC5 link with the relay UE, or may inform the remote UE to update (or modify) the PC5 link and include a new PC5 cause value to indicate a change of PDU session (of the relay UE on the Uu interface) due to SSC mode 3
The relay UE should inform each remote UE to perform a 5G ProSe direct link identifier update procedure and include a cause value to indicate that the change is due to a change in PDU session as a result of SSC mode 3 (or as a result of re-establishment of a new PDU session on the Uu interface optionally due to SSC mode 3, or as a result of a pending change in IP address or IP prefix or an impact to the existing IP address or prefix). The relay UE may also include any of the information listed above.

Upon reception of any of the PC5 messages or indications as described above, or notifications as described above, optionally from a relay UE, the remote UE may take any of the actions below in any order or combination:
The remote UE may release the PC5 link with the relay UE. The remote UE may then establish a new PC5 link to continue its services
The remote UE may perform a PC5 link modification procedure or a 5G ProSe direct link identifier update procedure towards the relay UE. As part of any of this subsequent procedure (e.g. 5G ProSe direct link identifier update procedure), the relay UE may provide any new IP address or prefix which is associated with the new PDU session.

Note: when the remote UE takes any of the actions described above towards the relay UE, the relay UE should ensure that the new request-either to establish a new PC5 link or to perform 5G ProSe direct link identifier update procedure-should be linked to the new PDU session which was requested to be established by the network. As such, the relay UE may first establish the new PDU session before taking any of the actions above, or may first inform the remote UEs and then establish the new PDU session (due to SSC mode 3 e.g. due to receiving 5GSM cause #39) optionally after at least one remote UE attempts to take any of the actions described above e.g. after at least one remote UE performs the 5G ProSe direct link identifier update procedure.
Option 2: The relay UE should initiate the release of the PC5 link with the remote UEs that are served on the PDU session which is being impacted due to SSC mode 3

When a relay UE with a PDU session for which the SSC mode is 3, needs to (re-)establish the session due to receiving 5GSM cause value #39, and the relay UE is serving at least one remote UE, where optionally the relay UE is in connected mode or optionally there is an active PC5 link (or direct connection) with at least one remote UE such that data is being exchanged with the remote UE (and optionally the PDU session in question is used for this purpose), then the relay UE can behave using any of the techniques described below in any order or combination:
The relay UE should initiate the release of the PC5 link towards each remote UE which is served on the PDU session in question, and may provide a new cause value to indicate that the reason is due to SSC mode 3 for which a new session is to be established. Note that any cause value may be used to provide this indication. Optionally the relay UE can indicate that the remote UE should re-establish the PC5 link with the relay UE e.g. the cause value on the PC5 message may indicate a new cause value such as “PC5 link re-activation requested”.
The relay UE should release any PC5 QoS flow towards a remote UE where the PC5 QoS flow is linked to (or served on) the PDU session in question. The relay UE may include any of the cause values listed earlier.

Note that the relay UE may first activate or establish a new PDU session (e.g. due to SSC mode 3, e.g. due to receiving 5GSM cause value #39 as described herein) before taking any of the actions above.

The following text may be proposed as a standards description solution based on the proposal above:

“If:
a) the initiating UE acts as 5G ProSe layer-3 UE-to-network relay UE; and
b) the 5G ProSe layer-3 UE-to-network relay UE has established a new PDU session established after receiving the 5GSM cause value #39 “reactivation requested” during a network-initiated PDU session modification procedure as specified in 3GPP TS 24.501;
the initiating UE should initiate the 5G ProSe direct link release procedure. The initiating UE should include a PC5 signalling protocol cause which may be any existing cause value or a new cause value indicating that the PC5 link should be re-established or re-activated.

Note that the relay UE may also include other information in the PC5 link release message. Note also that the initiation of the release procedure means that the relay UE should send the PROSE DIRECT LINK RELEASE REQUEST message, optionally towards the remote UE.
Option 3: The relay UE should initiate the 5G ProSe direct link identifier update procedure towards each remote UE which is currently served on the PDU session in question

For the scenario in question, in certain examples, the relay UE should perform the 5G ProSe direct link identifier update procedure towards each remote UE which is currently served by the PDU session for which the relay received the request to reactivate the PDU session, e.g. with 5GSM cause value #39, as indicated by the network. This is done by sending the PROSE DIRECT LINK IDENTIFIER UPDATE REQUEST message.

The relay UE may first establish the new PDU session and then perform the 5G ProSe direct link identifier update procedure towards each remote UE. The relay UE should at least provide a new IP address or new IP prefix (in accordance with the new session) that is obtained or determined by the relay UE e.g. using existing procedures (such as but not limited to obtaining IP prefixes from the network e.g. from the SMF). The relay UE may indicate with a PC5 cause value that the reason for this is due to SSC mode 3 or due to a new PDU session which has been established due to SSC mode 3.

As such, the relay UE should behave as described above optionally after receiving a request to reactivate a PDU session (with 5GSM cause value #39) and optionally after establishing a new PDU session with the network.

The following is an example of standards proposal solution based on the solution described above:

“If the 5G ProSe direct link identifier update procedure is triggered after the 5G ProSe layer-3 UE-to-network relay UE establishes a new PDU session due to receiving 5GSM cause #39 “reactivation requested” during a network initiated PDU session modification procedure as described in 3GPP TS 24.501 [11], the initiating UE shall create a PROSE DIRECT LINK IDENTIFIER UPDATE REQUEST message. In this message, the initiating UE:
a) may include the initiating UE's new layer-2 ID assigned by itself;
b) may include the new MSB of K_{NRP-sess} ID; and
c) should include the new assigned IP address/prefix for the target UE if IP communication is used and changed and the 5G ProSe direct link is not for 5G ProSe direct communication between 5G ProSe layer-2 remote UE and 5G ProSe layer-2 UE-to-network relay UE.

Note that the relay UE may include more information in the PROSE DIRECT LINK IDENTIFIER UPDATE REQUEST message although not shown above.

Note that although different options are described herein, any parts (including all parts) from the different options may be used (possibly together) in any suitable combination or order. Moreover, any indication from any of the options can also be applied in another option even if not explicitly listed in that option. As such, all the techniques described herein can apply regardless of which option they are listed in. The individual options listed and described above are not to be considered as potential independent solutions only, but they can also be used in conjunction with other solution options in any order or combination, and furthermore all the details from any solution can be used with any other solution option described herein.

FIG. 1 illustrates 5G ProSe Communication via 5G ProSe Layer-3 UE-to-Network Relay without N3IWF.

Referring to FIG. 1, at step 1a, authorization and provisioning for layer-3-UE-to-NW Relay is performed. At step 1b, authorization and provisioning for Remote UE is performed. At step 2, a PDU session establishment is performed. At step 3, a discovery procedure is performed. At step 4, establishment of connection for unicast mode communication is performed. (Relay UE may establish a new PDU session) At step 5, IP address/prefix allocation is performed. At step 6, a layer-2 link modification is performed. (Relay UE may modify existing PDU session for relaying) At step 7, Remote UE report (remote user ID, remote UE info) is performed. At step 8, a traffic is relayed.

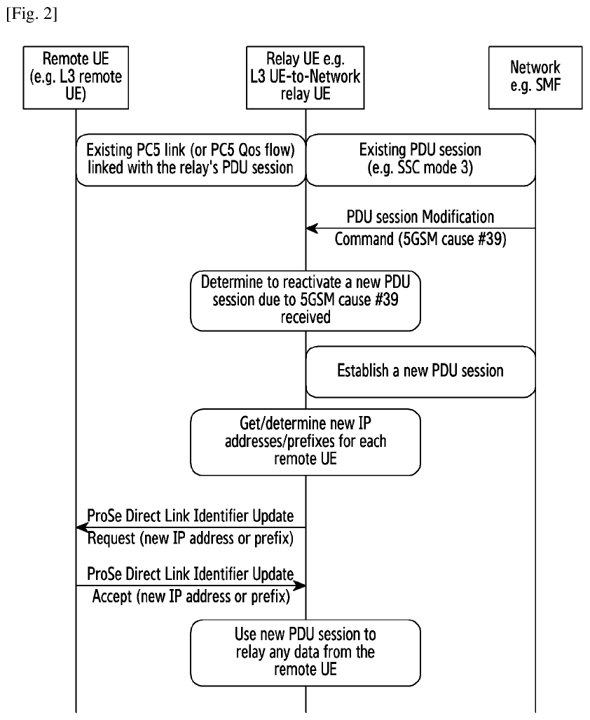

FIG. 2 illustrates some of the techniques described herein. Although FIG. 2 shows one remote UE, the technique illustrated in FIG. 2 can also apply when there is more than one remote UE. As such, the use of one remote UE is for brevity only and not a restriction.

Referring to FIG. 2, PC5 link (or, PC5 quality of service (QoS) flow) linked with the relay's PDU session exists. A PDU session (e.g., SSC mode 3) exists between the relay UE and the network (e.g., SMF). Network transmits a PDU session modification command (5GSM cause #39) to the relay UE. The relay UE determines to reactivate a new PDU session due to 5GSM cause #39 received. A new PDU session is establish between the relay UE and the network. The relay UE gets/determines a new IP addresses/prefixes for each remote UE. The relay UE transmit a Prose Direct Link Identifier Update request (new IP address or prefix) to the remote UE. The remote UE transmits a Prose Direct Link Identifier Update accept (new IP address or prefix) to the Relay UE. The relay UE uses the new PDU session to relay any data from the remote UE.

The skilled person will appreciate that FIG. 2 may be modified as appropriate to depict any of the other techniques and options described herein.

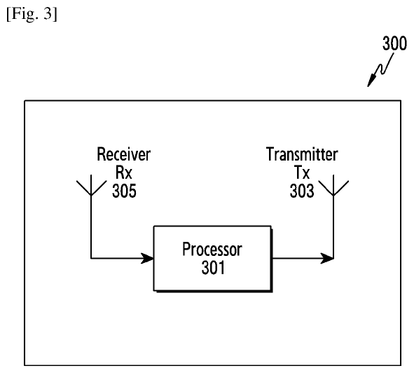

FIG. 3 is a block diagram of an exemplary network entity that may be used in examples of the present disclosure. For example, the UE, Relay UE, NG-RAN, AMF, SMF, UPF and/or other NFs in the examples of FIGS. 1 and 2 may be provided in the form of the network entity illustrated in FIG. 3. The skilled person will appreciate that a network entity may be implemented, for example, as a network element on a dedicated hardware, as a software instance running on a dedicated hardware, and/or as a virtualised function instantiated on an appropriate platform (e.g. on a cloud infrastructure).

The entity 300 comprises a processor (or controller) 301, a transmitter 303 and a receiver 305. The receiver 305 is configured for receiving one or more messages from one or more other network entities, for example as described above. The transmitter 303 is configured for transmitting one or more messages to one or more other network entities, for example as described above. The processor 301 is configured for performing one or more operations, for example according to the operations as described above.

A method, for a first UE providing a relay function between a network and a second UE is provided. wherein a first data session associated with a first IP address is established between the first UE and the network for data relayed between the second UE and the network. The method comprises receiving, from the network, a message requesting data session modification and initiating release of a link, between the first UE and the second UE, and associated with the first data session, if (i) the first data session is associated with a predetermined mode, and (ii) the message comprises a predetermined indication.
wherein the predetermined mode is SSC mode 3.
wherein the predetermined indication is cause value #39 “reactivation requested”.
wherein the first data session is a PDU session.
wherein the message comprises a PDU SESSION MODIFICATION COMMAND message.
wherein the link comprises a PC5 link.
wherein initiating release of the link comprises initiating a ProSe direct link release procedure.
wherein the first UE comprises a ProSe layer-3 UE-to-network relay UE.

A method further comprises, in response to the message, establishing a second data session, associated with a second IP address different from the first IP address, for data relayed between the second UE and the network.
wherein the second data session is established before release of the link is initiated.
wherein the second data session is established before the first data session is terminated.
wherein the message comprises information indicating a lifetime of the first data session.
wherein the message is received from an SMF entity.
wherein the second UE is out of coverage of the network.
wherein the message indicates a request to change a data session anchor point.

A UE configured to perform a method above described is provided.

A network (or wireless communication system) comprising a first UE according to claim 16, a second UE and a network entity (e.g. an SMF entity) is provided.

A computer program comprising instructions which, when the program is executed by a computer or processor, cause the computer or processor to carry out a method above described.

A computer or processor-readable data carrier having stored thereon a computer program is provided.

The techniques described herein may be implemented using any suitably configured apparatus and/or system. Such an apparatus and/or system may be configured to perform a method according to any aspect, embodiment, example or claim disclosed herein. Such an apparatus may comprise one or more elements, for example one or more of receivers, transmitters, transceivers, processors, controllers, modules, units, and the like, each element configured to perform one or more corresponding processes, operations and/or method steps for implementing the techniques described herein. For example, an operation/function of X may be performed by a module configured to perform X (or an X-module). The one or more elements may be implemented in the form of hardware, software, or any combination of hardware and software.

It will be appreciated that examples of the present disclosure may be implemented in the form of hardware, software or any combination of hardware and software. Any such software may be stored in the form of volatile or non-volatile storage, for example a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape or the like.

It will be appreciated that the storage devices and storage media are embodiments of machine-readable storage that are suitable for storing a program or programs comprising instructions that, when executed, implement certain examples of the present disclosure. Accordingly, certain examples provide a program comprising code for implementing a method, apparatus or system according to any example, embodiment, aspect and/or claim disclosed herein, and/or a machine-readable storage storing such a program. Still further, such programs may be conveyed electronically via any medium, for example a communication signal carried over a wired or wireless connection.

While the invention has been shown and described with reference to certain examples, it will be understood by those skilled in the art that various changes in form and detail may be made therein without departing from the scope of the invention, as defined by the appended claims.

### ABBREVIATIONS AND DEFINITIONS

In the present disclosure, the following acronyms/definitions are used.
3GPP 3rd Generation Partnership Project
5G 5th Generation
5GC 5G Core
5GS 5G System
5GSM 5G Session Management
AMF Access and Mobility management Function
DNN Data Network Name
ID Identification/Identity
IE Information Element
IP Internet Protocol
L3 Layer 3
MSB Most Significant Bit
N3IWF Non-3GPP Interworking Function
NAS Non Access Stratum
NG Next Generation
NR New Radio
NRF Network Repository Function
PC5 Direct communication link between capable ProSe UEs
PDU Protocol Data Unit
PLMN Public Land Mobile Network
ProSe Proximity Services
QoS Quality of Service
RAN Radio Access Network
RAT Radio Access Technology
RRC Radio Resource Control
SMF Session Management Function
S-NSSAI Single Network Slice Selection Assistance Information
SSC Service and Session Continuity
TS Technical Specification
UE User Equipment
UPF User Plane Function
Uu Air interface between terminal and base station/access point

1. A method performed by a relay user equipment (UE) in a wireless communication system, the method comprising:
receiving, from a base station, a protocol data unit (PDU) session modification command message associated with a first PDU session, the PDU session modification command message including a cause value for requesting a PDU session reactivation;
establishing a second PDU session based on the PDU session modification command message; and
initiating a release procedure for a PC5 direct link associated with the first PDU session established for relaying a traffic of a remote UE.

2. The method of claim 1, wherein a service and session continuity (SSC) mode of the first PDU session corresponds to an SSC mode 3 in which changes to a user plane are visible to a remote UE.

3. The method of claim 1, wherein the relay UE includes a layer-3 UE-to-network (U2N) relay UE for a 5G proximity services (ProSe).

4. The method of claim 1, wherein the initiating of the release procedure comprises:
transmitting, to the remote UE, a request message for releasing the PC5 direct link between the relay UE and the remote UE.

5. The method of claim 1, wherein the PDU session modification command message is received from a session management function (SMF) entity via the base station.

6. The method of claim 1, wherein the PDU session modification command message includes information on a life time of the first PDU session, and
wherein the first PDU session is maintained during the life time.

7. The method of claim 1, wherein the second PDU session is established before the PC5 direct link is released, and
wherein the second PDU session is establish before the first PDU session is terminated.

8. The method of claim 1, wherein the first PDU session is associated with a first internet protocol (IP) address, and the second PDU session is associated with a second IP address different from the first IP address.

9. A relay user equipment (UE) in a wireless communication system, the relay UE comprising:
a transceiver; and
a controller coupled with the transceiver and configured to:
receive, from a base station, a protocol data unit (PDU) session modification command message associated with a first PDU session, the PDU session modification command message including a cause value for requesting a PDU session reactivation,
establish a second PDU session based on the PDU session modification command message, and
initiate a release procedure for a PC5 direct link associated with the first PDU session established for relaying a traffic of a remote UE.

10. The relay UE of claim 9, wherein a service and session continuity (SSC) mode of the first PDU session corresponds to an SSC mode 3 in which changes to a user plane are visible to a remote UE.

11. The relay UE of claim 9, wherein the relay UE includes a layer-3 UE-to-network (U2N) relay UE for a 5G proximity services (ProSe).

12. The relay UE of claim 9, wherein the controller is configured to:
transmit, to the remote UE, a request message for releasing the PC5 direct link between the relay UE and the remote UE.

13. The relay UE of claim 9, wherein the PDU session modification command message is received from a session management function (SMF) entity via the base station.

14. The relay UE of claim 9, wherein the PDU session modification command message includes information on a life time of the first PDU session, and
wherein the first PDU session is maintained during the life time.

15. The relay UE of claim 9, wherein the second PDU session is established before the PC5 direct link is released, and
wherein the second PDU session is establish before the first PDU session is terminated.
